(19) United States
(12) Patent Application Publication
(10) Pub. No.: US 2010/0128007 A1
(43) Pub. Date: May 27, 2010

(54) Accelerometer Guided Processing Unit

(76) Inventor: Terry Lynn COLE, Austin, TX (US)

Correspondence Address: HAMILTON & TERRILE, LLP - AMD, P.O. BOX 203518, AUSTIN, TX, 78720, US

(21) Appl. No.: 12/468,355

(22) Filed: May 19, 2009

Related U.S. Application Data
(60) Provisional application No. 61/116,851, filed on Nov. 21, 2008.

(51) Int. Cl. G09G 5/00

(52) U.S. Cl. 345/184

(57) ABSTRACT

Described herein is a computing device for running an application that requires graphics and/or video processing capabilities. The computing device includes a display device, an accelerometer, and a processing unit. The application running on the computing device is configured to provide image data corresponding to an image for display on a virtual screen, wherein the virtual screen is larger than the display device. The accelerometer is configured to provide movement data based on motion of the computing device. The processing unit is configured to receive the image data and the movement data and provide only a portion of the image for display on the display device based on the movement data from the accelerometer.

### CROSS REFERENCE TO RELATED APPLICATIONS

This application claims benefit under 35 U.S.C. § 119(e) to U.S. Provisional Patent Application 61/116,851, entitled “Accelerometer Guided Processing Unit,” to Terry Lynn COLE, filed on Nov. 21, 2008, the entirety of which is hereby incorporated by reference as if fully set forth herein.

### BACKGROUND OF THE INVENTION

1. Field of the Invention

The present invention is generally directed to computing devices, and more particularly directed to computing devices that process graphics and/or video data.

2. Background Art

Mobile computing devices have become very popular. For example, many people have a mobile telephone, a smartphone, a personal digital assistant (PDA), a digital audio player (e.g., MP3 player), a handheld video game system, and/or some other type of mobile computing device. These mobile computing devices may run an application (e.g., an end-user application) that triggers graphics processing tasks and/or video processing tasks. The application may be, for example, a video game, a web browser, a photo-editing application, a computer-aided design (CAD) application, a computer-aided manufacturing (CAM) application, or some other application that requires the execution of graphics processing tasks.

To properly display graphics for such applications, many mobile computing devices include a graphics processing unit (GPU)—i.e., an integrated circuit specially designed to perform graphics processing tasks. Several layers of software separate the application from the GPU. The application communicates with an application programming interface (API). An API allows the application to output graphics data and commands in a standardized format, rather than in a format that is dependent on the GPU. The commands typically include the geometry and textures of objects and control information regarding how the objects should be displayed (e.g., whether to rotate, stretch, and/or magnify the objects). The API communicates with a driver. The driver translates standard code received from the API into a native format of instructions understood by the GPU. The instructions the GPU receives typically includes the coordinates of all the objects for display and the control information provided by the application. Based on these instructions, the GPU provides frame data for display on a display device (e.g., screen) of the mobile computing device.

Unfortunately, the display device of many mobile computing devices is not very large. As a result, the display device may be large enough to display only a small portion of the content of an application at any one time. To allow users to view the other portions of the content of the application, conventional mobile computing devices use one of two mechanisms.

According to a first conventional mechanism, a user can scroll through the content of the application by using a touch screen, a mouse, a roller ball, a button, and/or some other type of user-input device. But these types of user-input devices are too constraining because a user cannot control the on-screen content in an intuitive manner.

According to a second conventional mechanism, the mobile computing device includes an accelerometer to provide gyroscopic input to allow a user to manipulate the on-screen content in an intuitive manner. Conventionally, however, this mechanism requires a complex, application-level solution to simply mimic a user-input device. An application-level solution is too slow for many types of graphics processing tasks (such as, for example, video games). And many applications are not written to receive gyroscopic input, and therefore the applications would need to be reprogrammed to receive such input.

Given the foregoing, what is needed are systems, methods, and apparatuses for allowing a user to manipulate on-screen content of a mobile computing device in an intuitive and fast manner.

### BRIEF SUMMARY OF THE INVENTION

The present invention meets the above-described needs by providing systems, methods, and apparatuses for allowing a user to manipulate on-screen content of a mobile computing device in an intuitive and fast manner. In particular, embodiments of the present invention use an accelerometer for allowing a user to manipulate the on-screen content in an intuitive manner. And, unlike conventional mechanisms, the gyroscopic data from the accelerometer is provided to a processing unit, which can process the data faster than a software-level solution (e.g., application-level solution).

According to an embodiment of the present invention there is provided a computing device for running an application. The computing device includes a display device, an accelerometer, and a processing unit. The application running on the computing device is configured to provide image data corresponding to an image for display on a virtual screen, wherein the virtual screen is larger than the display device of the computing device. The accelerometer is configured to provide movement data based on motion of the computing device. The processing unit is configured to receive the image data and provide only a portion of the image for display on the display device based on the movement data from the accelerometer.

According to another embodiment of the present invention there is provided a processing unit for use in a computing device. The processing unit is configured to receive image data provided by an application, wherein the application is configured to provide image data corresponding to an image for display on a virtual screen. The virtual screen is larger than a display device of the computing device. The processing unit is also configured to receive movement data from an accelerometer based on motion of the computing device and provide only a portion of the image for display on the display device based on the movement data from the accelerometer.

According to a further embodiment of the present invention there is provided a method for displaying an image on a display device of a computing device. The method includes receiving image data provided by an application, wherein the application is configured to provide image data corresponding to an image for display on a virtual screen. The virtual screen is larger than a display device of the computing device. The method also includes receiving movement data from an accelerometer based on motion of the computing device and providing only a portion of the image for display on the display device based on the movement data from the accelerometer.

Further features and advantages of the invention, as well as the structure and operation of various embodiments of the invention, are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a perspective view of an example computing device with respect to a large virtual screen.

FIG. 2 depicts a block diagram of example components included in the example computing device of FIG. 1.

FIG. 3 depicts an example application stack in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Overview

The present invention provides systems, methods, and apparatuses that allow a user to manipulate on-screen content of a mobile computing device in an intuitive and fast manner. In this document, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention is directed to a processing device for processing data for display on a display device based on input from an accelerometer. For illustrative purposes only, and not limitation, embodiments are described herein in terms of a GPU. A person skill in the relevant art(s) will appreciate, however, that embodiments of the present invention may be applied to video processing units (VPUs) that process video data for display on a display device based on input from an accelerometer. Accordingly, GPUs and VPUs are contemplated within the spirit and scope of embodiments of the present invention.

According to an embodiment of the present invention, a GPU manages a large virtual screen, even on a small device. Like a conventional GPU, the application (e.g., end-user application) provides a GPU of an embodiment of the present invention with control information and coordinates of objects to be displayed. Unlike a conventional GPU, however, a GPU of an embodiment also has access to an accelerometer input. Based on information from the accelerometer, this GPU generates its own control information for manipulating content of the viewport. In this way, a GPU of an embodiment of the present invention can ignore the control information from the application because the GPU generates its own control information based on the information from the accelerometer.

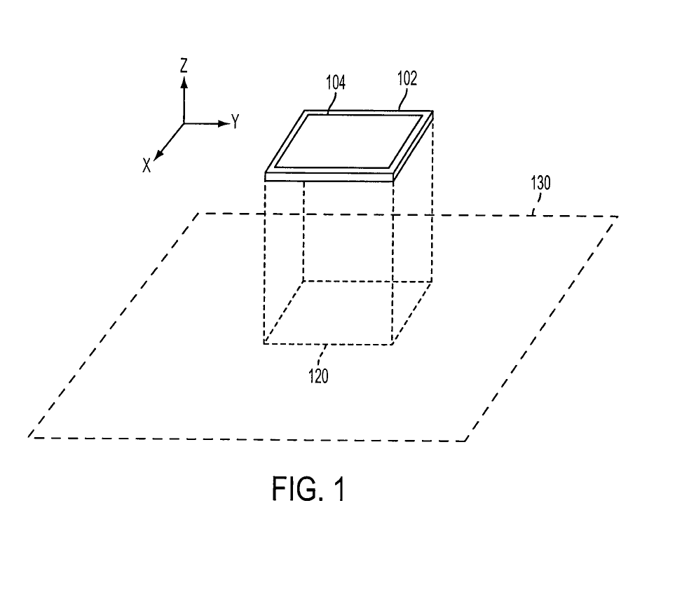

For example, FIG. 1 depicts a perspective view of an example mobile computing device 102 with respect to a large virtual screen 130 of an embodiment of the present invention. The usage model for this embodiment is that of a large map spread on the table, wherein mobile computing device 102 serves as a magnifying glass. According to this usage model, a display device 104 (e.g., screen) of mobile computing device 102 displays only a portion 120 of virtual screen 130 as illustrated in FIG. 1.

Hardware-based solutions provided by embodiments of the present invention allow a user to control which portion of virtual screen 130 is displayed on display device 104 based on intuitive movements of mobile computing device 102. In these embodiments, mobile computing device 102 includes an accelerometer and a GPU (not shown). When the user changes the orientation of mobile computing device 102, the accelerometer senses the orientation change and sends corresponding data to the GPU. The GPU, in turn, controls the portion of virtual screen 130 displayed on display device 104 based on the data from the accelerometer. Unlike conventional mechanisms, an application running on mobile computing device 102 can simply render to virtual screen 130. The GPU clips the image data from the application to display only portion 120 on display device 104. Because these embodiments provide hardware-based solutions, the content displayed on display device 104 can be manipulated more quickly than conventional, software-based solutions. As a result, these embodiments of the present invention are suitable for many different types of applications, including video game applications.

The GPU may also be configured to provide feedback information based on the content displayed on display device 104. Based on this feedback information, an application may, for example, limit its work if it is rendering many changes to virtual screen 130 that are not visible on display device 104. Alternatively, the GPU may provide the feedback information to the user when the application is rendering many changes to virtual screen 130 that are not visible on display device 104. For example, in a video-game context, if the user is focused to the left but the game has begun to draw an evil villain entering from the right, the GPU may trigger mobile computing device 102 to provide a mechanical alert (such as a vibration), an audio alert, or some other type of alert to warn the user of the presence of the evil villain.

Described in more detail below are an example computing device and an example application stack in which the GPU may be implemented in accordance with embodiments of the present invention.

### II. An Example Mobile Computing Device

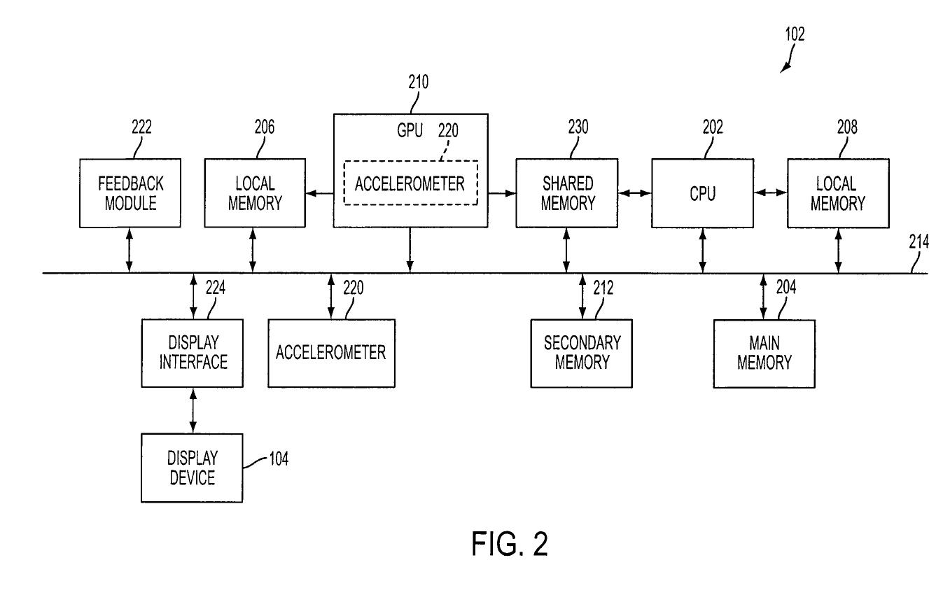

FIG. 2 depicts a block diagram illustrating example components included in mobile computing system 102 in accordance with an embodiment of the present invention. It is to be appreciated, however, that these example components are presented for illustrative purposes only, and not limitation. Mobile computing device 102 may not include all the components illustrated in FIG. 2 and may include additional components not illustrated in FIG. 2. And the components illustrated may be coupled together in a different manner than that illustrated in FIG. 2 as would be apparent to a person skilled in the relevant art(s).

Referring to FIG. 2, mobile computing device 102 includes a central processing unit (CPU) 202, a GPU 210, local memories 206 and 208, a shared memory 230, main memory 204, secondary memory 212, an accelerometer 220, a display interface 224, and a feedback module 222, which are each coupled to a communications infrastructure 214. Communications infrastructure 214 may comprise a bus—such as, for example, a peripheral component interface (PCI) bus, an accelerated graphics port (AGP) bus, and a PCI Express (PCIE) bus—or some other type of communications infrastructure for providing communications between components of mobile computing system 102.

GPU 210 assists CPU 202 by performing certain special functions, usually faster than CPU 202 could perform them in software. GPU 210 may be integrated into a chipset and/or CPU 202. In an embodiment, GPU 210 decodes instructions in parallel with CPU 202 and execute only those instructions intended for it. In another embodiment, CPU 202 sends instructions intended for GPU 210 to a command buffer.

Local memories 206 and 208 are available to GPU 210 and CPU 202, respectively, in order to provide faster access to certain data (such as data that is frequently used) than would be possible if the data were stored in main memory 204 or secondary memory 212. Local memory 206 is coupled to GPU 210 and also coupled to communications infrastructure 214. Local memory 208 is coupled to CPU 208 and also coupled to communications infrastructure 214.

Shared memory 230 is shared by GPU 210 and CPU 202. Shared memory 230 may be used to pass instructions and/or data between GPU 210 and CPU 202.

Main memory 204 is preferably random access memory (RAM). Secondary memory 212 may include, for example, a hard disk drive and/or a removable storage drive (such as, for example, a flash drive, a floppy disk drive, a magnetic tape drive, an optical disk drive). As will be appreciated, the removable storage unit includes a computer-readable storage medium having stored therein computer software and/or data. Secondary memory 212 may include other devices for allowing computer programs or other instructions to be loaded into mobile computing device 102. Such devices may include, for example, a removable storage unit and an interface. Examples of such may include a program cartridge (such as, for example, a video game cartridge) and cartridge interface, a removable memory chip (such as an erasable programmable read only memory (EPROM), or programmable read only memory (PROM)) and associated socket.

Accelerometer 220 is configured to sense movement of mobile computing device 102. These movements may include, but are not limited to, linear displacements, rotations, tilts, vibrations, and combinations thereof. Accelerometer 220 may also be configured to sense when mobile computing device 102 is shaken or tapped. Based on the movement sensed, accelerometer 220 provides movement data to GPU 210. In an embodiment, accelerometer 220 may be included in mobile computing device 102 as an independent component. In this embodiment, accelerometer 220 provides the movement data to GPU 210 via communications infrastructure 214. In another embodiment, accelerometer 220 is incorporated in GPU 210. Including accelerometer 220 in GPU 210 may reduce the cost, size, and power consumption of mobile computing device 102.

Feedback module 222 is configured to provide feedback information to a user of mobile computing device 102. For example, feedback module 222 may provide feedback information when an application renders large amounts of data to virtual screen 130 that is not visible on display device 104. In embodiments, feedback module 222 may generate an audio alert, may flash a light, may cause mobile computing device 102 to vibrate, or may provide some other type of feedback to the user.

Mobile computing device 102 also includes a display device 104 coupled to communications infrastructure 214 via display interface 224. Display interface 224 forwards, graphics, text, and other data from communications infrastructure 214 (or from GPU 210) for display on display device 104. In an embodiment, display device 104 is a display screen (such as, for example, a touchscreen display, a liquid crystal display (LCD) screen, etc.).

### III. Example Application Stack

As mentioned above, mobile computing device 102 may run an application that requires the execution of graphics processing tasks. GPU 210 performs graphics processing tasks for the application. The graphics processing commands issued by the application are processed by several layers of software before reaching GPU 210. Importantly, the application and software layers process graphics commands for display on virtual screen 130. GPU 210 is configured to perform all the necessary clipping operations for displaying portion 120 of virtual screen 130 on display device 104.

A. Elements Included in an Example Application Stack

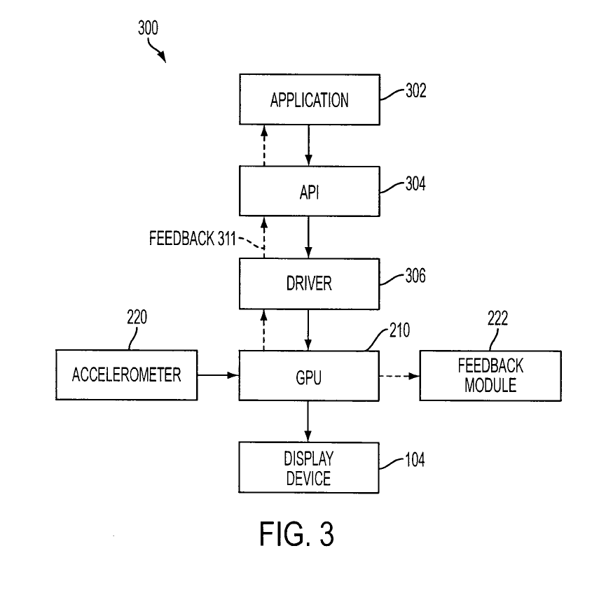

FIG. 3 depicts a block diagram 300 illustrating an example application stack in accordance with an embodiment of the present invention. Block diagram 300 illustrates hardware components (including GPU 210, accelerometer 220, feedback module 222, and display device 104 discussed above with respect to FIG. 2) and software components (including an application 302, an API 304, and a driver 306). API 304 and driver 306 separate application 302 from GPU 210, as described in more detail below.

Application 302 is an end-user application that requires graphics processing capability. Application 302 may comprise, for example, a video game application, a web browser, a photo-editing application, a CAD application, a CAM application, or the like. Application 302 sends graphics processing commands to API 304. In accordance with an embodiment of the present invention, the graphics processing commands sent by application 302 may correspond to an image for display on virtual screen 130. In addition, application 302 may send control information regarding how objects are to be displayed on display device 104. The control information from application 302 may specify a magnification, a rotation, a stretch, or some other type of command as would be apparent to persons skilled in the relevant art(s).

API 304 is an intermediary between application software, such as application 302, and graphics hardware, such as GPU 210, on which the application software runs. With new chipsets and entirely new hardware technologies appearing at an increasing rate, it is difficult for application developers to take into account, and take advantage of, the latest hardware features. It is also increasingly difficult for application developers to write applications specifically for each foreseeable set of hardware. API 304 prevents application 302 from having to be too hardware specific. Application 302 can output graphics data and commands to API 304 in a standardized format, rather than directly to GPU 210. API 304 may comprise a commercially available API (such as, for example, DirectX® developed by Microsoft Corp. of Mountain View, Calif. or OpenGL® developed by Silicon Graphics, Inc. of Sunnyvale, Calif.). Alternatively, API 304 may comprise a custom API. API 304 communicates with driver 306. In accordance with an embodiment of the present invention, the graphics commands and data that API 304 communicates to driver 306 correspond to an image for display on virtual screen 130.

Driver 306 is typically written by the manufacturer of GPU 210 and translates standard code received from API 304 into native format understood by GPU 210. Driver 306 communicates with GPU 210. In accordance with an embodiment of the present invention, the graphics commands and data that driver 306 communicates to GPU 210 correspond to an image for display on virtual screen 130.

GPU 210 receives the native format data from driver 306 and movement data from accelerometer 220. The native format data may include the control information from application 302, along with a command from driver 306 to ignore this control information. GPU 210 includes a shader and other associated logic for performing graphics processing. Based on the movement data from accelerometer 220, GPU 210 is configured to generate its own control information. GPU 210 uses this control information to perform clipping operations to cause only portion 120 of virtual screen 130 to be displayed on display device 104. When rendered frame data processed by GPU 210 is ready for display it is sent to display device 104.

B. Example Operation

Example operation of embodiments of the present invention are now described with reference to FIGS. 1 and 3.

In an embodiment, GPU 210 is configured to manipulate the content displayed on display device 104 based on several different types of movements of mobile computing device 102. For example, GPU 210 may be configured so that the user can tilt mobile computing device 102 about the x-axis or the y-axis to look at different portions of virtual screen 130. And GPU 210 may be further configured so that the user can intuitively control zoom in and out by moving mobile computing device 102 along the z-axis. Rotating mobile computing device 102 by a predetermined angle (e.g., 90 degrees) about the z-axis, can be configured to change the orientation of virtual screen 130. All these manipulations of the content displayed on display device 104 occur without changing anything application 302 is doing. Application 302 simply renders to virtual screen 130. GPU 210 does all the work of clipping the viewport based on the movement data from accelerometer 220.

GPU 210 may send feedback information to application 302. Application 302 may use the feedback information in several different ways. For example, if application 302 is sending many changes to virtual screen 130 that are not visible on display device 104, application 302 may limit the amount of work it sends.

As another example, the feedback information from GPU 210 to application 302 may include the movement data from accelerometer 220. In this way, accelerometer 220 may operate as a gyroscopic mouse. Tapping on mobile computing device 102 would be analogous to clicking a mouse button. Moving mobile computing device 102 through space would be analogous to moving the mouse. Accelerometer 220 would sense such movements of mobile computing device 102 and send corresponding movement data to GPU 210. GPU 210, in turn, would provide this movement data to application 302 as input in a similar manner as application 302 would receive input from a user's interaction with a mouse.

GPU 210 may be configured to provide different types of feedback information to application 302 depending on the type of application running on mobile computing device 102. Provided below are embodiments in which application 302 is a photo editing application and a video game application. It is to be appreciated, however, that these embodiments are provided for illustrative purposes only, and not limitation. A person skilled in the relevant art(s) will appreciate that GPU 210 can be configured to provide different types of feedback information depending on the type of application running on mobile computing device 102. Such other configurations of GPU are contemplated within the spirit and scope of the present invention.

In the photo-editing embodiment of application 302, GPU 210 may be configured to cause a picture on display device 104 to be rotated in response to rapid torque of mobile computing device 102. Tapping on mobile computing device 102 once may bring up a menu. Tilting mobile computing device 102 up and down (e.g., in the x-direction) may move up and down the menu. Tapping mobile computing device 102 again may select an item on the menu. Double tapping may bring up a different menu. Shaking mobile computing device may erase the content (e.g., a photo) displayed on display device 104. Setting mobile computing device 102 down may save the content (e.g., the photo). Setting mobile computing device 102 down upside down may save and close an editing session.

In the video-game embodiment of application 302, mobile computing device 102 may act as a window into a three-dimensional, virtual world. As mobile computing device 102 is moved through space, GPU 210 may be configured to display the content of the three-dimensional, virtual world on display device 104. Tapping on mobile computing device 102 and other radical movements of mobile computing device 102 may be received as input to application 302.

GPU 210 may also send feedback information to feedback module 222. Based on this feedback information, feedback module 222 provides an alert (such as, for example, an audio alert, a flashing light, a vibration of mobile computing device 102, etc.) to a user. The alert may be dependent on the type of application running on mobile computing device 102. For example, in the photo-editing embodiment of application 302, if application 302 pops up information that is not visible on display device 104 (i.e., pops up information that is not contained in portion 120 of virtual screen 130), feedback module 222 may cause mobile computing device 102 to vibrate or may provide a “bird's eye” view of the entire virtual screen 130 indicating where the activity is. In the video-game embodiment of application 302, if application 302 is drawing a villain in a portion of virtual screen 130 that is not visible on display device 104, feedback module 222 may cause mobile computing device 102 to vibrate, may provide an audio alert, or may trigger some other type of alert for the user. In the foregoing embodiments, application 302 may, but is not required to, receive the feedback information from GPU 210.

### IV. Example Software Implementations of GPU 210

In addition to hardware implementations of GPU 210, GPU 210 may also be embodied in software disposed, for example, in a computer-readable medium configured to store the software (such as, for example, a computer-readable program code). This may be accomplished, for example, through the use of general programming languages (such as C or C++), hardware description languages (HDL) including Verilog HDL, VHDL, Altera HDL (AHDL) and so on, or other available programming and/or schematic capture tools (such as circuit capture tools). The program code can be disposed in any known computer-readable medium including semiconductor, magnetic disk, optical disk (such as CD-ROM, DVD-ROM). It is understood that the functions accomplished and/or structure provided by the systems and techniques described above can be represented in a core (such as a GPU core) that is embodied in program code and may be transformed to hardware as part of the production of integrated circuits.

### V. Conclusion

Set forth above are example systems, methods, and apparatuses that allow a user to manipulate on-screen content of a mobile computing device in an intuitive and fast manner. Such systems, methods, and apparatuses provide several advantages. For example, embodiments of the present invention allow existing applications to access a larger virtual screen, without modifications to the existing applications.

Another example advantage is that embodiments of the present invention allow for more user space on a display device because applications will not need to devote screen areas to scroll bars.

A further example advantage is that embodiments of the present invention save space by allowing a single accelerometer to be accessed by not only the GPU, but also an auxiliary power unit (APU) or video processing unit (VPU) through an API.

A further example advantage is that embodiments of the present invention allow the vector processor pipelines of a GPU or VPU to perform rapid calculations based on raw accelerometer data. These rapid calculations allow faster real-time signals to be made available to applications or other peripherals. For example, a well-known application for an accelerometer is to perform parking the hard drive heads. But this application typically uses a dedicated accelerometer tied to the hard drive controller, because the CPU is not fast enough to provide real-time signals. Unlike the CPU, however, the GPU has no non-real-time OS running. So, the GPU can respond fast enough to send a real-time park signal to the hard drive. Referring to FIG. 2, for example, GPU 210 may provide real-time signals to a peripheral component (such as the hard drive of main memory 204) via bus 214 or to CPU 202 via API 304.

A further example advantage is that embodiments of the present invention can save power by pushing the desktop model to the GPU one time. The GPU retrieves all needed memory directly, rather than performing complex clipping and scrolling functions in the CPU and then pushing each frame to the GPU.

A further example advantage is that embodiments of the present invention reduces the space, cost, and power consumption of hardware found in typical accelerometers.

Typical accelerometers include hardware that performs basic calculations prior to providing the output. Such hardware can be removed from accelerometers of embodiments of the present invention because the GPU can perform the basic calculations of such hardware using the already existing logic and memory of the GPU.

While various embodiments of the present invention have been described above, it should be understood that they have been presented by way of example only, and not limitation. It will be apparent to persons skilled in the relevant art that various changes in form and detail can be made therein without departing from the spirit and scope of the invention. For example, although described above in terms of a handheld mobile computing device, embodiments of the present invention may be used in any device that moves and has a display. Such devices may include, but are not limited to, a mobile telephone, a PDA, a smartphone, a laptop computer, a camera, a reading pad, a digital sign, and the like.

In addition, embodiments of the present invention apply not only to graphics data, but also to video data. Although conventional video processors typically execute motion estimation and picture stabilization, such conventional video processors typically do not receive input from an accelerometer regarding the actual movement of the device. Rather, conventional motion estimation and picture stabilization algorithms attempt to estimate the movement of the device based only on the video data that is being processed. In accordance with an embodiment of the present invention, however, a video processing unit processes video data based on input from an accelerometer. For example, the accelerometer input may be used to improve conventional motion estimation and picture stabilization algorithms.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. Thus, the breadth and scope of the present invention should not be limited by any of the above-described exemplary embodiments, but should be defined only in accordance with the following claims and their equivalents.

What is claimed is:

1. A computing device for running an application, the computing device comprising:
a display device, wherein the application is configured to provide image data corresponding to an image for display on a virtual screen, the virtual screen being larger than the display device;
an accelerometer configured to provide movement data based on motion of the computing device; and
a processing unit configured to receive the image data and the movement data and provide only a portion of the image for display on the display device based on the movement data from the accelerometer.

2. The computing device of claim 1, wherein the accelerometer is configured to provide the movement data based on at least one of a tilt of the computing device in a first direction, linear movement of the computing device along a first direction, and a rotation of the computing device about a first axis.

3. The computing device of claim 1, wherein the accelerometer is configured to provide the movement data when the computing device is tapped or shaken.

4. The computing device of claim 1, wherein the processing unit is further configured to provide another portion of the image for display on the display device based on the movement data from the accelerometer.

5. The computing device of claim 1, wherein the processing unit is further configured to provide a larger or smaller portion of the image for display on the display device based on the movement data from the accelerometer.

6. The computing device of claim 1, further comprising:
a feedback module configured to provide an alert;
wherein the processing unit is configured to trigger the feedback module to provide the alert when the application provides a predefined amount of image data corresponding to portions of the image that are not presently for display on the display device.

7. The computing device of claim 1, wherein the processing unit comprises a graphics processing unit.

8. The computing device of claim 1, wherein the processing unit comprises a video processing unit.

9. The computing device of claim 1, wherein the processing unit is configured to perform calculations based on the movement data from the accelerometer and provide results of the calculations to an other component of the computing device.

10. The computing device of claim 9, wherein the processing device is configured to provide the calculations to a hard drive via a bus signal.

11. The computing device of claim 9, wherein the processing device is configured to provide the calculations to a central processing unit via an application programming interface.

12. A processing unit for use in a computing device, wherein the processing unit is configured to:
receive image data provided by an application, wherein the application is configured to provide image data corresponding to an image for display on a virtual screen, the virtual screen being larger than a display device of the computing device;
receive movement data from an accelerometer based on motion of the computing device; and
provide only a portion of the image for display on the display device based on the movement data from the accelerometer.

13. The processing unit of claim 12, wherein the processing unit is configured to receive the movement data from the accelerometer based on at least one of a tilt of the computing device in a first direction, linear movement of the computing device along a first direction, and a rotation of the computing device about a first axis.

14. The processing unit of claim 12, wherein the processing unit is configured to receive the movement data from the accelerometer when the computing device is tapped or shaken.

15. The processing unit of claim 12, wherein the processing unit is further configured to provide another portion of the image for display on the display device based on the movement data from the accelerometer.

16. The processing unit of claim 12, wherein the processing unit is further configured to provide a larger or smaller portion of the image for display on the display device based on the movement data from the accelerometer.

17. The processing unit of claim 12, wherein the processing unit is configured to trigger a feedback module to provide an alert when the application provides a predefined amount of image data corresponding to portions of the image that are not presently for display on the display device.

18. The processing unit of claim 12, wherein the processing unit is embodied in software on a computer-readable medium.

19. The processing unit of claim 18, wherein the processing unit is embodied in hardware description language software on the computer-readable medium.

20. The processing unit of claim 12, wherein the processing unit comprises a graphics processing unit.

21. The processing unit of claim 12, wherein the processing unit comprises a video processing unit.

22. A method for displaying an image on a display device of a computing device, the method comprising:
(a) receiving image data provided by an application, wherein the application is configured to provide image data corresponding to an image for display on a virtual screen, the virtual screen being larger than a display device of the computing device;
(b) receiving movement data from an accelerometer based on motion of the computing device; and
(c) providing only a portion of the image for display on the display device based on the movement data from the accelerometer.

23. The method of claim 22, wherein (b) comprises:
receiving the movement data from the accelerometer based on at least one of a tilt of the computing device in a first direction, linear movement of the computing device along a first direction, and a rotation of the computing device about a first axis.

24. The method of claim 22, wherein (b) comprises:
receiving the movement data from the accelerometer when the computing device is tapped or shaken.

25. The method of claim 22, further comprising:
providing another portion of the image for display on the display device based on the movement data from the accelerometer.

26. The method of claim 22, further comprising:
providing a larger or smaller portion of the image for display on the display device based on the movement data from the accelerometer.

27. The method of claim 22, further comprising:
triggering an alert when the application provides a predefined amount of image data corresponding to portions of the image that are not presently for display on the display device.
